(19) United States
(12) Patent Application Publication
(10) Pub. No.: US 2006/0197288 A1
(43) Pub. Date: Sep. 7, 2006

(54) Metal laminate cylinder head gasket

(75) Inventor: Masanori Sakamoto, Utsunomiya-shi (JP)

Correspondence Address: KANESAKA BERNER AND PARTNERS LLP, SUITE 300, 1700 DIAGONAL RD, ALEXANDRIA, VA, 22314-2848, US

(73) Assignee: ISHIKAWA GASKET CO., LTD., Minato-ku (JP)

(21) Appl. No.: 11/365,603

(22) Filed: Mar. 2, 2006

(30) Foreign Application Priority Data
Mar. 3, 2005 (JP) 2005-059386

(51) Int. Cl. F02F 11/00

(52) U.S. Cl. 277/592

(57) ABSTRACT

A cylinder head gasket is formed by a metal substrate, and a supporting plate laminated on the metal substrate. The metal substrate and the supporting plate include cylinder bores, fluid holes, and a plurality of bolt holes. The metal substrate includes a sealing bead around the cylinder bore thereof to form a bore sealing portion. The cylinder bore of the supporting plate is greater than the sealing bead without laminating the sealing bead, so that a total plate thickness at the bore sealing portion is less than a laminated portion of the metal substrate and the supporting plate outside the bore sealing portion.

### BACKGROUND OF THE INVENTION AND RELATED ART STATEMENT

The present invention relates to a metal laminate cylinder head gasket to be installed between a cylinder head and the cylinder block of an automobile engine and so on.

As shown in FIGS. 9, 10 and 12 of Japanese Utility Model Publication (KOKOKU) No. 4-16027, a metal laminate cylinder head gasket provided with a bead in a bore sealing portion around a combustion chamber bore on one of multiple laminated plate members is well-known. This metal laminate cylinder head gasket generates high surface pressure on a contact portion of the bead and improves the sealing characteristic when the metal laminate cylinder head gasket is tightened between the cylinder head and the cylinder block.

However, in the above-described gasket, there is no difference in the total plate thickness at a bore sealing portion providing the bead and at portions other than the above-described bore sealing portion, or the total plate thickness at the bore sealing portion is slightly greater than the total plate thickness at the portion other than the above-described bore sealing portion. Accordingly, when the cylinder head and the cylinder block are strongly tightened, the bead is completely bent or flattened. As a result, the surface pressure decreases due to creep relaxation of the bead while using.

The present invention has been made in order to solve the above-described problem, and an object of the present invention is to provide a metal laminate cylinder head gasket that can restrain the bead from being entirely bent or flattened in a simple way when the cylinder head and the cylinder block are strongly tightened. Thus, the creep relaxation is prevented from being generated in the sealing bead, and the gasket can follow even to relative displacement between the cylinder head and the cylinder block accompanied with a pressure change within a combustion chamber.

Further objects and advantages of the invention will be apparent from the following description of the invention.

### SUMMARY OF INVENTION

In order to solve the above-mentioned problems, a metal laminate cylinder head gasket of the present invention is installed between the cylinder head and the cylinder block, which include a combustion chamber bore, and a fluid bore disposed around the combustion chamber bore, and seals around the respective bores.

The metal laminate cylinder head gasket is constituted by laminating multiple metal plates including at least one metal substrate and a supporting plate. In the metal substrate, a bore corresponding to the combustion chamber bore is provided and a sealing bead is formed in a bore sealing portion around the bore. Also, the metal substrate is provided with a through-hole corresponding to the fluid bore.

In the supporting plate, the portion corresponding to the bore sealing portion of the metal substrate is cut away or deleted, and the through-hole corresponding to the fluid bore is provided. The total plate thickness of the bore sealing portion of the metal substrate is made thinner than the laminated portion of the metal substrate and supporting plate.

In the metal laminate cylinder head gasket of the present invention, the sealing bead of the bore sealing portion of the metal substrate can be a full bead or half bead, or an accessory bead can be formed at the cut edge of the supporting plate which is adjacent to the bore sealing portion of the metal substrate. In the metal laminate cylinder head gasket of the invention with the above-described structure, the total thickness of the plates at the bore sealing portion of the metal substrate is thinner than the total thickness of the plates in other parts. As a result, even if the tightening force between the cylinder head and cylinder block is applied to the bore sealing portion, the sealing bead of the bore sealing portion can be prevented from being completely bent or flattened because a surrounding portion of the supporting plate which is laminated around the bore sealing portion becomes a stopper. Accordingly, the metal laminate cylinder head gasket can restrain creep relaxation of the sealing bead.

In addition, as a preferred embodiment of the present invention, a part of the supporting plate adjacent to the sealed part of the through-hole of the metal substrate corresponding to the fluid bore is cut away. When the cylinder head gasket is constituted as described above, surface pressure due to the tightening force between the cylinder head and the cylinder block can be concentrated on the sealing portion around the through-hole corresponding to the fluid bore, and the sealing portion can be stably sealed.

According to the above-described invention, the metal laminate cylinder head gasket can restrain the bead from being completely bent or flattened in a simple way when the cylinder head and the cylinder block are strongly tightened. Accordingly, the metal laminate cylinder head gasket can restrain the creep relaxation from being generated in the sealing bead, and can follow even to relative displacement between the cylinder head and cylinder block accompanied with a pressure change within the combustion chamber.

### BRIEF DESCRIPTION OF THE DRAWINGS

FIG. 1 is a plan view of a metal laminate cylinder head gasket according to the present invention;

FIG. 2 is a cross sectional view taken along line 2-2 in FIG. 1;

FIG. 3 is a cross sectional view of another embodiment in a position similar to FIG. 2;

FIGS. 4A and 4B are cross sectional views of different embodiments in a position similar to FIG. 2;

FIG. 5 is a cross sectional view of a further embodiment in a position similar to FIG. 2;

FIG. 6 is a cross sectional view of a still further embodiment in a position similar to FIG. 2;

FIG. 7 is a cross sectional view of a still further embodiment in a position similar to FIG. 2;

FIG. 8 is a plan view of a still further embodiment, shown as in FIG. 1; and

FIG. 9 is a plan view of a still further embodiment, shown as in FIG. 1.

### DETAILED DESCRIPTION OF PREFERRED EMBODIMENTS

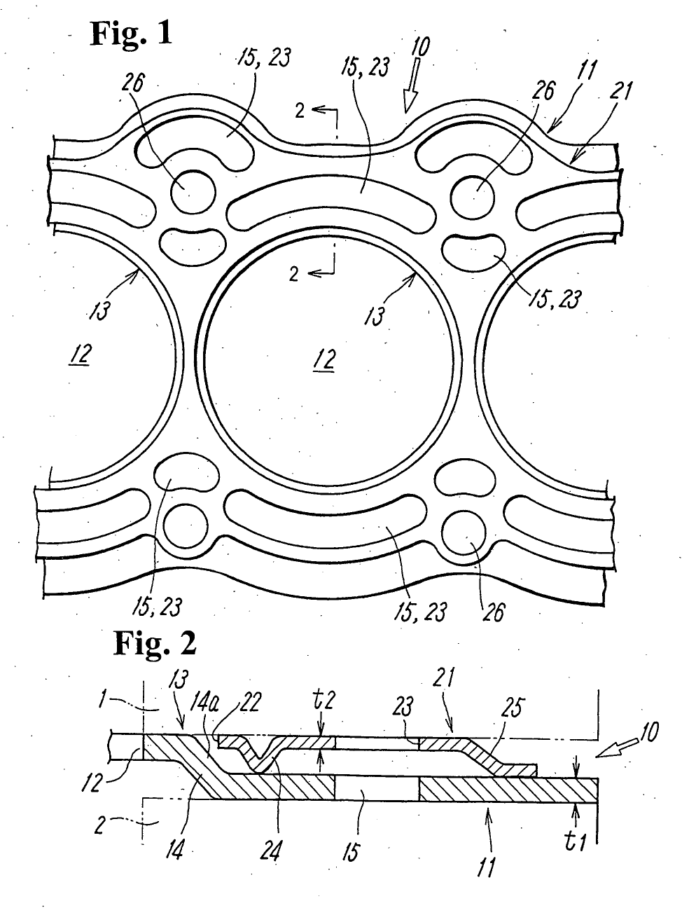

FIGS. 1 and 2 show an embodiment of a metal laminate cylinder head gasket according to the present invention.

A cylinder head gasket 10 is installed between a cylinder head 1 and a cylinder block 2, and includes cylinder bores and fluid holes disposed around the cylinder chamber bores to seal around the respective above-described bores. The cylinder head gasket 10 is constituted by laminating a metal substrate 11 formed of a metal plate and a supporting plate 21.

Incidentally, in the embodiment, the cylinder head gasket 10 is constituted by laminating two of the metal substrate 11 and the supporting plate 21. However, the cylinder head gasket 10 can be constituted by laminating multiple metal plates including the metal substrate 11 and the supporting plate 21.

Bores 12 corresponding to the combustion chamber bores are provided in the metal substrate 11, and sealing beads (half beads) 14 are formed in bore sealing portions 13 which are located around the bores 12. Also, the metal substrate 11 is provided with multiple through-holes 15 corresponding to the fluid holes provided in the cylinder head 1 and the cylinder block 2. Also, in the supporting plate 21, portions corresponding to the bore sealing portions 13 of the metal substrate 11 are cut away, and cut edges 22 abut against surroundings of the sealing beads 14 of the metal substrate 11, i.e., rising portions 14a for forming the sealing beads of the metal substrate 11.

Also, through-holes 23 corresponding to the fluid holes are provided and additionally, beads (full beads) 24 are provided on the side of the cut edges 22 of the supporting plate 21. Further, a bead (half bead) 25 is provided on the side of the outer circumferential edge, as well. Incidentally, the supporting plate 21 is laminated on the surface of the side where the sealing beads 14 rise in the bore sealing portions 13 of the metal substrate 11.

In the cylinder head gasket 10 including the above-described structure, a total plate thickness at the bore sealing portion 13 of the metal substrate 11 (in this embodiment, plate thickness of only metal substrate 11) is naturally made thinner than a total plate thickness at the laminate portion of the other metal substrate 11 and supporting plate 21. As a result, even if the tightening force between the cylinder head 1 and the cylinder block 2 are applied to the bore sealing portions 13, the sealing bead 14 at the bore sealing portions 13 can be prevented from being completely bent or flattened because a surrounding portion of the supporting plate 21 which is laminated around the bore sealing portions 13 becomes a stopper. Therefore, the creep relaxation of the sealing bead 14 can be restrained.

Moreover, as shown in FIG. 1, in the supporting plate 21, at least circumferences of the bore sealing portions 13 of the metal substrate 11; sealing portions around the through-holes 23 corresponding to the fluid holes; circumferences of bolt holes 26 for tightening the cylinder head 1 and cylinder block 2; and outer circumferential edges which include and surround the portions connecting the circumferences of the bore sealing portions 13, the sealing portions around the through-holes 23 and the circumferences of the bolt holes 26, can be formed within the outer circumferential edge of the metal substrate.

When the gasket is constituted by the above-described structure, the area of the supporting plate 21 becomes substantially small as compared with the metal substrate 11. As a result, the tightening force between the cylinder head and the cylinder block is concentrated on the supporting plate 21, i.e. surface pressure due to the tightening force can be concentrated on the sealing portions around the bore sealing portions 13 of the metal substrate 11 or the through-holes 23 corresponding to the fluid bores, so that the sealing portions can be stably sealed.

In addition, for example, in the metal laminate gasket, a metal plate formed of SUS 301 with a plate thickness t1 of 350 μm can be used as the metal substrate 11, and a metal plate formed of SUS 301 with a plate thickness t2 of 150 μm can be used as the supporting plate 21. However, the above-described metal plates show examples of the plate thickness and quality of material of the plates, and surely, the metal plates can be optionally selected according to a specification required for a gasket.

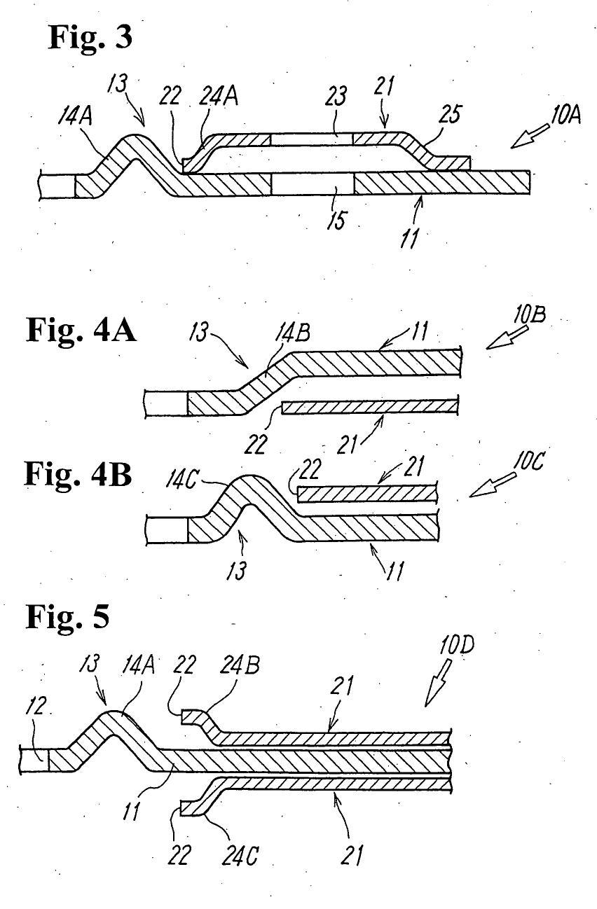

In a metal laminate cylinder head gasket 10A shown in FIG. 3, a sealing bead 14A at each bore sealing portion 13 of the metal substrate 11 is a full bead, and a bead 24A provided on the side of each cut edge 22 of the supporting plate 21 is a half bead. Other structures and functions of the embodiment are the same as those of the embodiment explained in FIGS. 1 and 2, so that the same symbols are used in the figures and the explanation thereof is omitted.

In addition, the bore sealing portion 13 of the metal substrate 11 and the end portion on the side of the cut edge 22 of the supporting plate 21 can be constituted as shown in FIG. 4A or 4B.

A metal laminate cylinder head gasket 10B as shown in FIG. 4A is an example which is provided with a sealing bead 14B formed of the half bead at the bore sealing portions 13 of the metal substrate 11, and the end portion on the side of the cut edge 22 of the supporting plate 21 has no bead. Also, a metal laminate cylinder head gasket 10C shown in FIG. 4B is an example which is provided with the sealing bead 14A formed of the full bead at the bore sealing portion 13 of the metal substrate 11, and the end portion on the side of the cut edge 22 of the supporting plate 21 has no bead. Even in these cases, there is no difference in function from the above-mentioned embodiment.

Also, the above-mentioned embodiment is constituted by laminating two sheets of the metal substrate 11 and supporting plate 21 as described previously. However, the gasket can be constituted by laminating three or more metal plates including the metal substrate 11 and supporting plate 21. For example, when the third metal plate is laminated in addition to the metal substrate 11 and supporting plate 21, the third metal plate having a function equal to the metal substrate 11 or supporting plate 21 can be laminated. However, the third metal plate having a function which is unrelated to the metal substrate 11 or supporting plate 21 can be laminated.

FIGS. 5-7 show metal laminate cylinder head gaskets 10D, 10E, 10F of embodiments constituted by laminating three metal plates.

An embodiment in FIG. 5 is a gasket 10D with the three metal sheets. The gasket 10D includes two sheets of the supporting plates 21 which sandwich the metal substrate 11 including the sealing bead 14A which is equal to the metal substrate 11 of the cylinder head gasket 10A in FIG. 3. The supporting plates 21 are disposed adjacent to the sealing bead 14A on both sides of the metal substrate 11 and are provided in such a way that the cut edges 22 are located on both sides and have half beads 24B, 24C whose cut edges project in opposite directions.

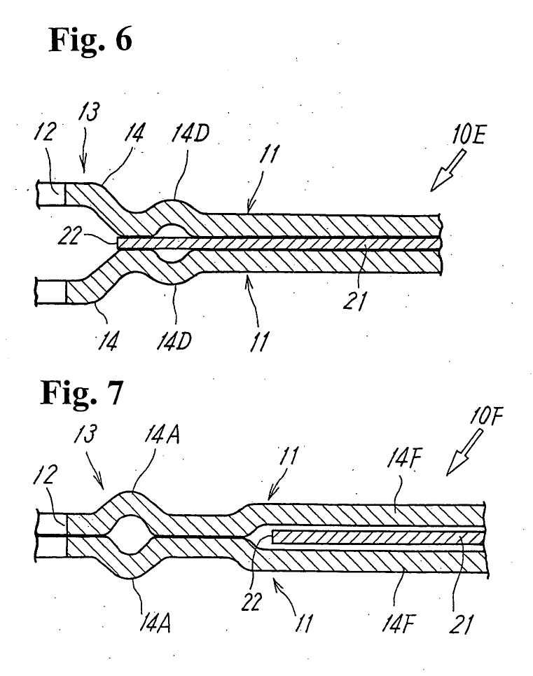

An embodiment in FIG. 6 is a gasket 10E including the sealing beads 14 in the form of the half bead, which has metal substrate 11 equal to that shown in FIGS. 1 and 2. Also, the gasket 10E is constituted by the three sheets in such a way that the two sheets of the metal substrates 11 include second full beads 14D projecting in the directions same as those of the beads 14. The two sheets of the metal substrates 11 sandwich a supporting plate 21 and the three sheets are laminated in such a positional relation that the sealing beads 14 project in opposed directions. The supporting plate 21 is provided in a position where the cut edge 22 contacts with initial rising ends of the sealing beads 14.

An embodiment in FIG. 7 is a gasket 10F including the sealing beads 14A, a part of which is similar to the cylinder head gasket 10A in FIG. 3. Also, the gasket 10F is constituted by the three sheets wherein each of the two sheets of the metal substrates 11 includes a half-bead-like rising area 14F which rises in the same direction as the sealing bead 14A. The metal substrates 11 are laminated in such a positional relation that the sealing beads 14A project in opposite directions, and the rising areas 14F sandwich the plate-like supporting plate 21. The supporting plate 21 is provided in such a way that the cut edge 22 is positioned at the rising end of the rising areas 14F.

Since the metal laminate cylinder head gaskets 10D, 10E, 10F substantively operate just like the metal laminate cylinder head gasket 10, a further explanation thereof is omitted.

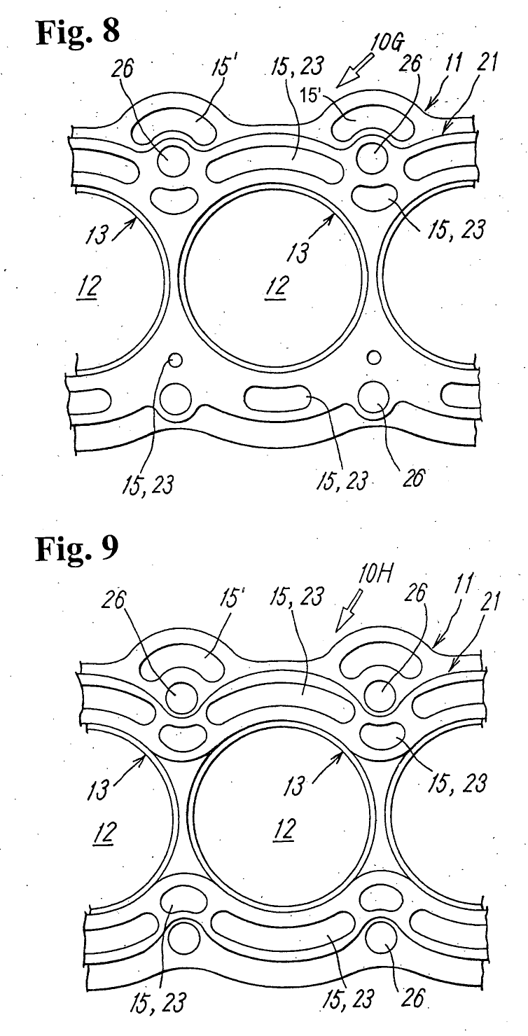

The metal laminate gasket of the invention can be constituted in the embodiments shown in FIGS. 8 and 9.

In the metal laminate cylinder head gasket 10G shown in FIG. 8, the sealing portions around the through-holes 15′ in the metal substrate 11, close to the outer circumference edge of the gasket, which correspond to the fluid holes, are omitted. As a result, the area of the supporting plate 21 is made additionally narrower and the pressure to the supporting plate 21 is increased. More specifically, seals (not shown in the figure) such as the full beads are formed around the through-holes 15′ close to the outer circumferential edge of one side (upside of the figure) of the metal substrate 11. The supporting plate 21 around the above-described through-holes 15′ is cut away or eliminated at a part adjacent to the full beads. More specifically, in the supporting plate 21, the outer circumferential edge is formed adjacent to the full beads, and the bead (half bead) 25 as shown in FIG. 2 is provided along the outer circumferential edge.

A metal laminate cylinder head gasket 10H as shown in FIG. 9 has an additionally narrower area in the supporting plate 21. In addition to the through-holes 15′ of the embodiment shown in FIG. 8, the sealing portions are omitted in the surrounding areas of the bolt bores 26 and between the bore sealing portions 13 of the metal substrate 11. As a result, the area of the supporting plate 21 is made furthermore narrower and the pressure to the supporting plate 21 is furthermore increased. Even in this embodiment, the seals (not shown in the figure) such as the full beads are formed around the through-holes 15 of the metal substrate 11. The supporting plate 21 which is located adjacent to the seals is cut away inside the bolt bores 26, and the outer circumferential edge is formed. Along the outer circumferential edge, the bead (half bead) 25 as shown in FIG. 2 is provided. The embodiments shown in FIGS. 8 and 9 have no substantial difference in function from the above-described embodiments.

Incidentally, the metal laminate gasket of the invention is not limited to the embodiments described hereinabove, and can be modified provided that it does not exceed the scope of claims.

The disclosure of Japanese Patent Application No. 2005-059386 filed on Mar. 3, 2005 is incorporated herein.

What is claimed is:

1. A cylinder head gasket comprising:
a first metal substrate for forming the gasket, including a first cylinder bore, at least one first fluid hole, a plurality of first bolt holes, and a first sealing bead formed a round the first cylinder bore to form a bore sealing portion, and
a first supporting plate laminated on the first metal substrate, and including a second cylinder bore, at least one second fluid hole and a plurality of second bolt holes, said second cylinder bore being greater than the first sealing bead formed around the first cylinder bore without laminating the first sealing bead so that a total plate thickness at the bore sealing portion is less than a laminated portion of the first metal substrate and the first supporting plate outside the bore sealing portion.

2. A cylinder head gasket according to claim 1, wherein said first supporting plate includes an outer edge spaced inwardly from an outer edge of the first metal substrate.

3. A cylinder head gasket according to claim 2, wherein said first supporting plate includes a first supporting bead around the second cylinder bore to seal the first and second cylinder bores by the first sealing bead and the first supporting bead.

4. A cylinder head gasket according to claim 3, wherein said first metal substrate has a thickness greater than that of the first supporting plate.

5. A cylinder head gasket according to claim 4, further comprising a second supporting plate having a second supporting bead, said second supporting plate being arranged so that the first metal substrate is sandwiched therebetween.

6. A cylinder head gasket according to claim 2, further comprising a second metal substrate having a second bore sealing bead around the first bore sealing bead, said first supporting plate being sandwiched between the first and second metal substrates without overlapping the first and second bore sealing beads.

7. A cylinder head gasket according to claim 6, wherein said first and second metal substrates include sub-beads around the first and second bore sealing beads.

8. A cylinder head gasket according to claim 7, wherein said sub-beads are formed of half beads projecting away from each other, said first supporting plate being situated outside the sub-beads.

9. A cylinder head gasket according to claim 4, wherein said first metal substrate includes another fluid hole, and a sealing member for sealing around the another fluid hole, said first supporting plate being formed not to entirely surround the another fluid hole.

10. A cylinder head gasket according to claim 1, wherein said first sealing bead in the bore sealing portion of said first metal substrate is a full bead or half bead.
